(19) United States
(12) Patent Application Publication
(10) Pub. No.: US 2025/0228216 A1
(43) Pub. Date: Jul. 17, 2025

(54) FEED LEVEL CONTROL SYSTEM AND METHODS

(71) Applicant: Randy Arnett, Ariton, AL (US)

(72) Inventor: Randy Arnett, Ariton, AL (US)

(21) Appl. No.: 19/016,605

(22) Filed: Jan. 10, 2025

Related U.S. Application Data
(60) Provisional application No. 63/620,627, filed on Jan. 12, 2024.

(51) Int. Cl. A01K 39/012

(52) U.S. Cl. CPC A01K 39/0125

(57) ABSTRACT

A system for controlling a feed level in a poultry feed network includes a feed chute coupled to receive feed from a feed source via a feedline, a feed pan coupled to receive feed from the feed chute and defining an airflow inlet, a fan positioned adjacent to the feed pan and operable to provide airflow to an interior of the feed pan via the airflow inlet, and a user-operable fan switch switchable between at least two positions and coupled to, and operable to control, the fan. The fan begins operation to provide the airflow when the fan switch is toggled to a first position and stops operation to provide the airflow when the fan switch is toggled to a second position. The airflow moves feed within the feed pan so that additional feed enters the feed pan from the feed chute, lowering a feed level within the feed chute.

### CROSS-REFERENCE TO RELATED APPLICATION

This application claims priority to U.S. Provisional Patent Application No. 63/620,627 filed Jan. 12, 2024, the contents of which are hereby incorporated by reference in their entirety.

### FIELD OF THE DISCLOSURE

The present disclosure generally related to a feed level control system, and more particularly to a feed level control system for use with one or more feed pans.

### BACKGROUND OF THE DISCLOSURE

Poultry house feed network systems are often configured to be automatically refilled using one feedline for distributing food to multiple feed pans. One feed pan, usually at the end of the feedline, is configured as a control feed pan and includes components for determining when because chickens have eaten enough feed so that additional feed should be provided to the pans of the feed network. However, chickens are not evenly distributed within a poultry house, and usually are moved by workers within the house based on the chickens' age. Chickens eat more from some feed pans than others, causing uneven feed consumption across feed pans of the feed network. It has been observed that chickens sometimes consume little or no feed from feed control pans during a feeding period. As a result, a feed level in a feed control pan may not accurately reflect a feed level of other feed pans across the feed network. This can delay or prevent feed distribution, often leaving feed pans toward the center of the feedline empty and limiting the feed available for chickens to eat near their location within the poultry house. Improved techniques for controlling poultry feed network levels are generally desirable.

### SUMMARY OF THE DISCLOSURE

According to one aspect of the present disclosure, a system for controlling a feed level in a poultry feed network may include a feed chute coupled to receive feed from a feed source via a feedline, a chute switch positioned within the feed chute, in communication with the feed source, and switchable between at least two positions, a feed pan coupled to receive feed from the feed chute and comprising an airflow inlet, a fan positioned adjacent to the feed pan and operable to provide an airflow to an interior of the feed pan via the airflow inlet, and a fan switch coupled to the fan. A first position of the chute switch may indicate that a level of feed within the feed chute is below the position of the chute switch within the feed chute, and a second position of the chute switch may indicate that a level of feed within the feed chute is at or above the position of the chute switch within the feed chute. When the chute switch is in the first position, the feed source may provide feed to the feed chute, and when the chute switch is in the second position the feed source may stop providing feed to the feed chute. Airflow moves feed within the feed pan so that additional feed enters the feed pan from the feed chute, thereby lowering a level of feed within the feed chute. The fan may begin operation to operation to provide the airflow when the fan switch is toggled to a first position, and the fan may stop operation to stop providing the airflow when the fan switch is toggled to a second position.

According to another aspect of the present disclosure, a method for controlling a feed level in a poultry feed network may include steps of coupling a feed chute to receive feed from a feed source via a feedline and positioning a chute switch within the feed chute, in communication with the feed source, and switchable between at least two positions. A first position of the chute switch may indicate that a level of feed within the feed chute is below the position of the chute switch within the feed chute, and a second position of the chute switch may indicate that a level of feed within the feed chute is at or above the position of the chute switch within the feed chute. When the chute switch is in the first position, the feed source may provide feed to the feed chute, and, when the chute switch is in the second position, the feed source may stop providing feed to the feed chute. The method may further include a step of coupling a feed pan to receive feed from the feed chute, the feed pan comprising an airflow inlet. Another step of the method may include positioning a fan adjacent to the feed pan and operable to provide an airflow to an interior of the feed pan via the airflow inlet, where the airflow moves feed within the feed pan so that additional feed enters the feed pan from the feed chute, thereby lowering a level of feed within the feed chute. The method may further include a step of coupling a fan switch to the fan, where the fan switch is switchable between at least two positions and operable to control operation of the fan. The fan may begin an operation to provide the airflow when the fan switch is in a first position, and the fan may stop the operation to provide the airflow when the fan switch is in a second.

According to another aspect of the present disclosure, a system for controlling a feed level in a poultry feed network may include a feed chute coupled to receive feed from a feed source via a feedline, a feed pan coupled to receive feed from the feed chute and defining an airflow inlet, a fan positioned adjacent to the feed pan and operable to provide airflow to an interior of the feed pan via the airflow inlet, and a user-operable fan switch switchable between at least two positions and coupled to, and operable to control, the fan. The fan may begin an operation to provide the airflow when the fan switch is toggled to a first position and may stop the operation to provide the airflow when the fan switch is toggled to a second position. The airflow may move feed within the feed pan so that additional feed enters the feed pan from the feed chute, thereby lowering a feed level within the feed chute.

These and other aspects, objects, and features of the present disclosure will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain view of the figures may be shown exaggerated in scale or in schematic in the interest of clarity and conciseness.

In the drawings:

FIG. 1 is a top schematic view of a poultry feed network, in accordance with some embodiments of the present disclosure.

FIG. 2 is a first side perspective view of a system for controlling distribution of feed to the poultry feed network of FIG. 1, in accordance with some embodiments of the present disclosure.

FIG. 3 is a second side perspective view of the system of FIG. 2.

FIG. 4 is top plan view of the system of FIG. 2.

FIG. 5 is a third perspective view of the system of FIG. 2.

FIG. 6A is a side schematic view of a system for controlling distribution of feed to the poultry feed network of FIG. 1 with a level of feed below a chute switch, in accordance with some embodiments of the present disclosure.

FIG. 6B is a side schematic view of the system of FIG. 6A with a level of feed above the chute switch, in accordance with some embodiments of the present disclosure.

FIG. 7 is a side schematic view of a system for controlling distribution of feed to the poultry feed network of FIG. 1 with an airflow guide, in accordance with some embodiments of the present disclosure.

FIG. 8A is a partial top perspective of an airflow guide for use in a system for controlling distribution of feed to the poultry feed network of FIG. 1, in accordance with some embodiments of the present disclosure.

FIG. 8B is a partial side perspective of the airflow guide of FIG. 8A.

FIG. 9 is a top plan view of a schematic of a system for controlling distribution of feed to the poultry feed network of FIG. 1 with an airflow guide, according to various examples.

FIG. 10 is a block diagram of a system for controlling distribution of feed to the poultry feed network of FIG. 1, in accordance with some embodiments of the present disclosure.

FIG. 11 is a block diagram of a controller of FIG. 10, in accordance with some embodiments of the present disclosure.

FIG. 12 is a side schematic view of the system for controlling distribution of feed of FIG. 10, in accordance with some embodiments of the present disclosure.

FIG. 13 is a flow diagram of a method for controlling a feed level in a poultry feed network, in accordance with some embodiments of the present disclosure.

### DETAILED DESCRIPTION

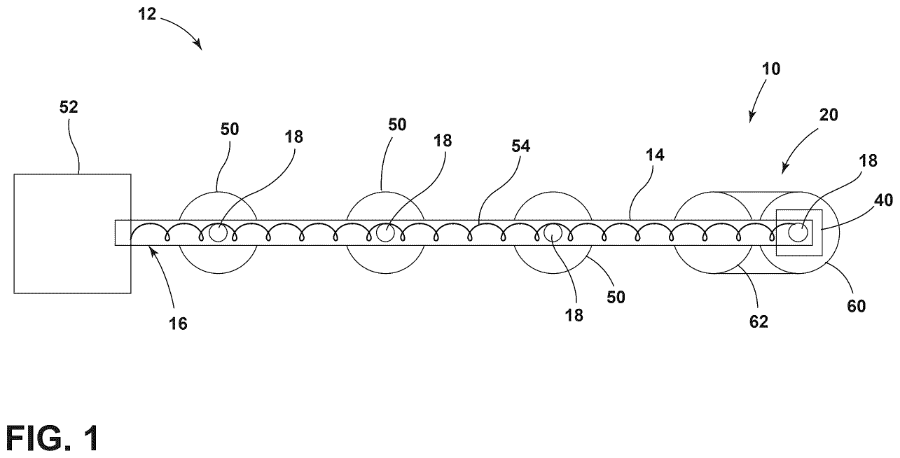

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As required, detailed examples of the present disclosure are disclosed herein. However, it is to be understood that the disclosed examples are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present disclosure.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and Bin combination; A and C in combination; B and C in combination; or A, B, and C in combination.

The following disclosure describes a system for controlling a feed level in a poultry feed network.

Referring generally to the figures, in some embodiments a system 10 may be implemented for controlling a feed level within a poultry feed network 12. The system 10 may include a feedline 14 operably coupled with a feed source 16 and a feed chute 18 coupled to receive feed from the feed source 16 via the feedline 14. A feed pan 20 is coupled to receive feed from the feed chute 18. In various examples, the feed chute 18 may be one of multiple feed chutes each operably coupled with a respective feed pan to provide feed to the pan 20 (for example, using gravity). The feed pan 20 may comprise an airflow inlet 22. A fan 24 may be positioned adjacent the feed pan 20 and may be operable to provide an airflow to an interior 28 of the feed pan 20 via the airflow inlet 22 of the feed pan 20. The airflow provided by the fan 24 moves feed within the interior 28 of the feed pan 20 so that additional feed enters the feed pan 20 from the feed chute 18, thereby lowering a level of feed 30 within the feed chute 18. A fan switch 32 may be coupled to the fan 24 and operable to control operation of the fan 24. The fan switch 32 may be switchable between at least two positions. When the fan switch 32 is toggled to a first position, the fan 24 may begin operation to provide the airflow. When the fan switch 32 is toggled to a second position, the fan 24 may stop operation to stop providing the airflow. A chute switch 34 may be positioned within the feed chute 18. The chute switch 34 may be in communication with the feed source 16 and switchable between at least two positions 36, 38. A first position 36 of the chute switch 34 indicates that the level of feed 30 within the feed chute 18 is below the position of the chute switch 34 within the feed chute 18. When the chute switch 34 is in the first position 36, the feed source 16 provides feed to the feed chute 18. A second position 38 of the chute switch 34 indicates that the level of feed 30 within the feed chute 18 is at or above the position of the chute switch 34 within the feed chute 18. When the chute switch 34 is in the second position 38 the feed source 16 stops providing feed to the feed chute 18. The chute switch 34 and the fan switch 32 may be in communication with at least one controller 38, which may be positioned either alone or with other components, within a housing 40.

Referring now to FIG. 1, the poultry feed network 12 includes a plurality of feed pans 50 that hold feed for chickens to eat. The feed source 16 provides feed to a pan 50 via feed chute 18. Chickens eat feed within their reach, near edges (e.g., an inner surface circumference of the pan 50) of the pan 50. Eventually, chickens may eat enough feed that there is insufficient feed between edges of the pan and feed beyond the chicken's reach (e.g., closer to the chute 18) to counteract the weight of feed in the chute 18, and the feed in the chute 18 pushes outward and into the interior of the pan 50. A feed cone 120 pushes the feed toward empty space between the cone 120 and edges of the pan 50 to backfill feed consumed by chickens. Feed may continue to exit the feed chute 18 until there is sufficient feed to counteract the weight of feed in the feed chute 18 and keep additional feed from leaving the feed chute 18 and entering the pan 50.

In some embodiments, there may be at least one feed pan 20 configured to control distribution of feed through the feedline 14, as discussed in more detail elsewhere herein. This at least one feed pan 20 may be referred to herein as a “control feed pan” and, as described further below, may comprise components for controlling operation of the feed network based on a level of feed detected in the control feed pan.

One or more of the plurality of feed pans 50 may be coupled with a feedline 14. The feedline 14 may be operably coupled with one or more of the plurality of feed pans 50, including at least one control feed pan 20. The feedline 14 may be operably coupled with a feed source 16. In various examples, feed may be guided through the feedline 14 from the feed source 16 (e.g., from a feed storage container 52) by an auger 54. The feed storage container 52 may be any or various combinations of any suitable means for storing feed such as, for example, a hopper, a container, a silo, a bag, a trough, etc. Together, the feed storage container 52 and any mechanism for moving feed from the feed storage container 52 to the feedline 14 (e.g., the auger 54) may comprise the feed source 16. However, it is contemplated that the feed source 16 may be any or various combinations of any suitable means of providing feed and guiding feed through the feedline 14 without departing from the scope of the present disclosure.

The feed source 16 is configured to selectively provide feed to each of the feed chutes 18 of the plurality of feed pans 50 via the feedline 14. As shown in FIG. 1, the feedline 14 may extend between the plurality of feed pans 50, and further may extend from the control feed pan 20 to a feed storage container 52. Each feed pan 50 may be operably coupled with a feed chute 18 configured to receive feed from the feedline 14. Alternatively, each feed chute 18 may be integrally formed with the respective feed pan 50.

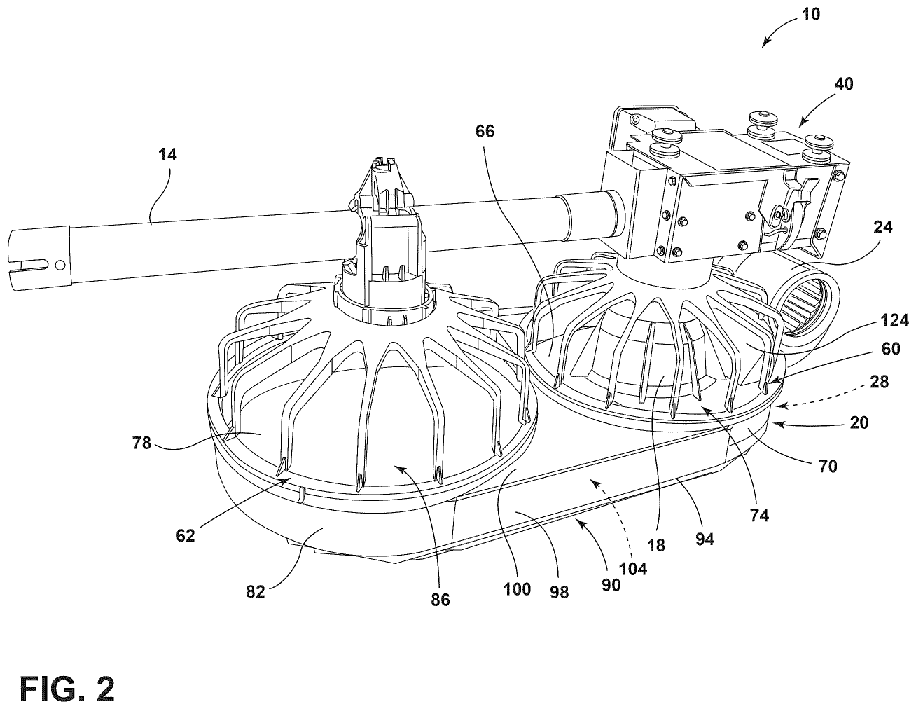

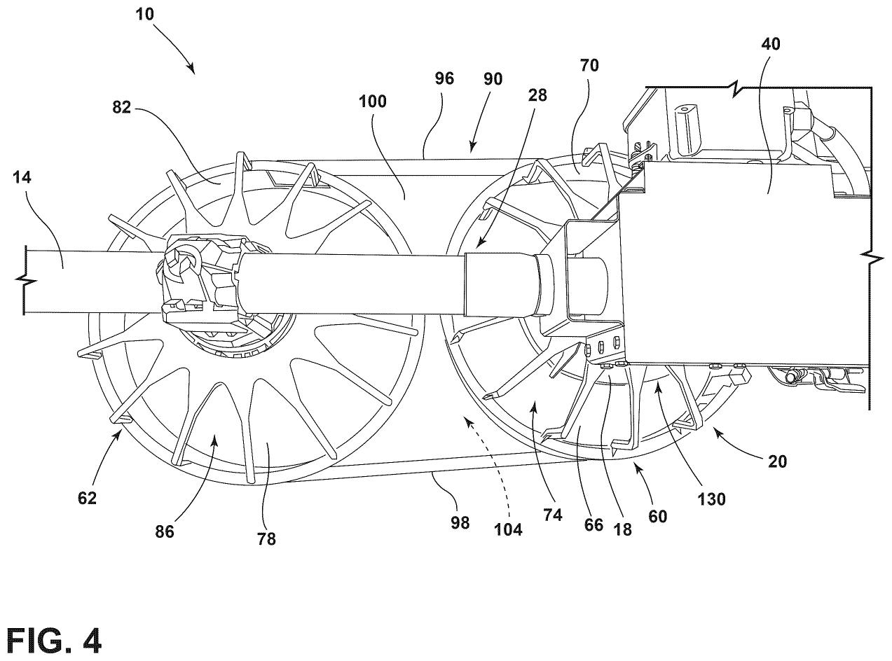

As previously introduced, the plurality of feed pans 50 includes at least one control feed pan 20 defining an interior 28 configured to receive and retain feed. As shown in FIGS. 2-4, the control feed pan 20 may include a primary feed pan 60 and an auxiliary feed pan 62. The auxiliary feed pan 62 may be operably coupled with the primary feed pan 60. In other examples, the auxiliary feed pan 62 may be integrally formed with the primary feed pan 60.

The primary feed pan 60 may include a bottom wall 66 and a side wall 70 extending upward from the bottom wall 66 and extending about at least part of a periphery of the bottom wall 66. The bottom wall 66 may be coupled with the side wall 70, or the bottom wall 66 may be integrally formed with the side wall 70. Together, the bottom wall 66 and the side wall 70 define an interior receiving space 74 of the primary feed pan 60.

The auxiliary feed pan 62 may further include a bottom wall 78 and a side wall 82 extending upward from the bottom wall 78 and extending about at least part of a periphery of the bottom wall 78. In various examples, the bottom wall 66 of the primary feed pan 60 and the bottom wall 78 of the auxiliary feed pan 62 may be integrally formed as a single wall. The bottom wall 78 of the auxiliary feed pan 62 may be coupled with, or may be integrally formed with, the side wall 82 of the auxiliary feed pan 62 and may extend about at least part of a periphery of the bottom wall 78 of the auxiliary feed pan 62. Together, the bottom wall 78 and the side wall 82 may define an interior receiving space 86 of the auxiliary feed pan 62. The interior receiving space 86 of the auxiliary feed pan 62 may be in communication with the interior receiving space 74 of the primary feed pan 60.

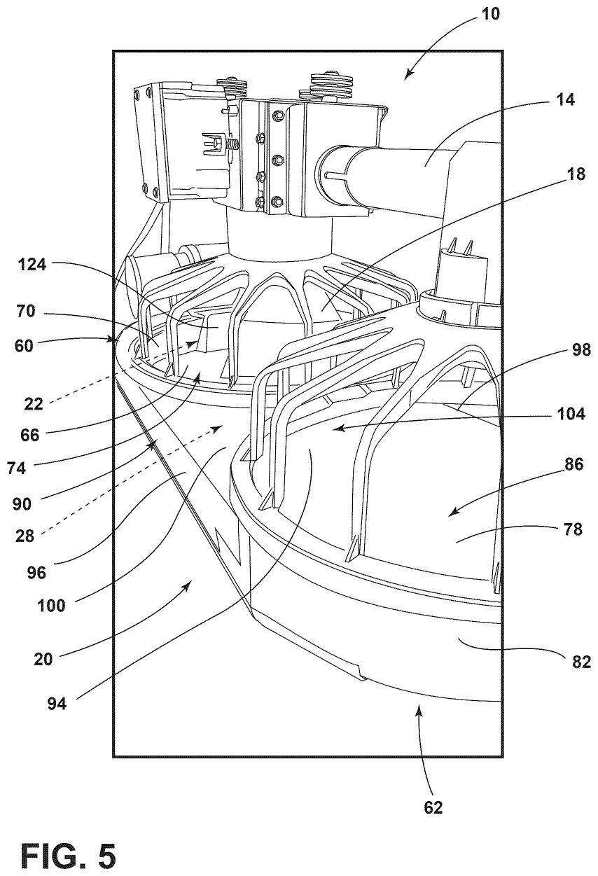

As shown in FIGS. 2-5, each of the primary feed pan 60 and the auxiliary feed pan 62 may be coupled with a central portion 90. The central portion 90 may include a bottom wall 94 coupled with or integrally formed with the bottom wall 66 of the primary feed pan 60 and the bottom wall 78 of the auxiliary feed pan 62. First and second side walls 96, 98 of the central portion 90 may be coupled with or integrally formed with the side walls 70, 82 of the primary feed pan 60 and the auxiliary feed pan 62. A top wall 100 may extend between the first and second sides walls 96, 98. The walls 94, 96, 98, 100 of the central portion 90 define a channel 104 in communication with the interior receiving space 74 of the primary feed pan 60 and the interior receiving space 86 of the auxiliary feed pan 62. Together, the interior receiving space 74 of the primary feed pan 60, the interior receiving space 86 of the auxiliary feed pan 62, and the channel 104 comprise the interior 28 of the control feed pan 20. It will be understood that, in examples where one or more of the interior receiving spaces 74, 86 and the channel 104 are not included, the interior 28 of the control feed pan 20 will be comprised of the included spaces. For example, the primary feed pan 60 and the auxiliary feed pan 62 may be shaped such that the central portion 90 is not required. In such an example, the interior receiving spaces 74, 86 of the primary feed pan 60 and the auxiliary feed pan 62 would comprise the interior 28 of the control feed pan 20.

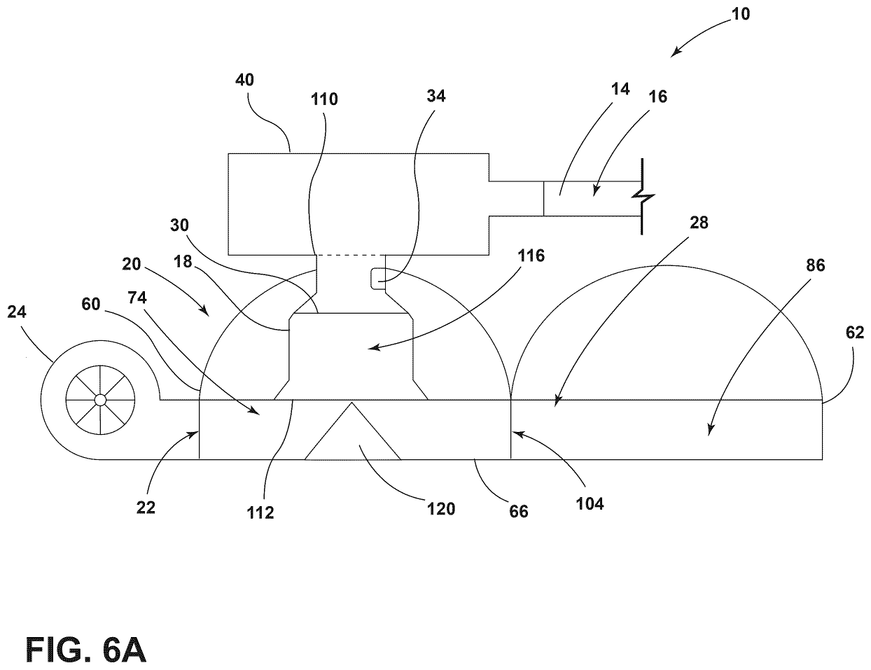

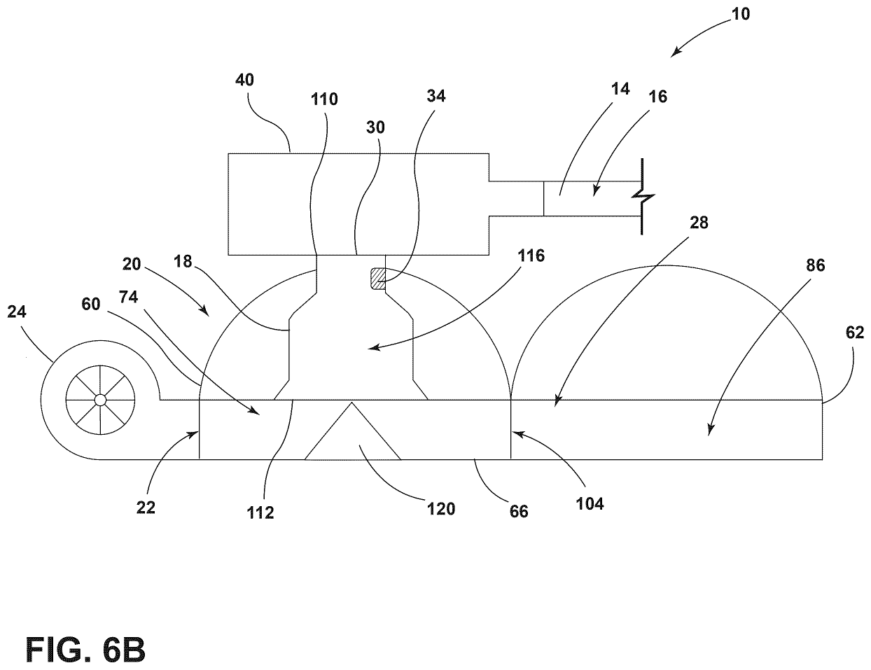

The control feed pan 20 further includes a feed chute 18 operably coupled with the feedline 14 at a first end 110 and spaced apart from the bottom wall 66 of the primary feed pan 60 at a second end 112. The feed chute 18 may be coupled with the feedline 14 to deliver feed from the feedline 14 to the primary feed pan 60. The feed chute 18 defines a feed channel 116 extending from the first end 110 to the second end 112 and in communication with the interior 28 of the primary feed pan 60. In various examples, the feed channel 116 may be centered with the control feed pan 20 (FIGS. 6A and 6B). In other words, the feed chute 18 may be positioned such that the feed channel 116 of the feed chute 18 is centered with the bottom wall 66 of the primary feed pan 60.

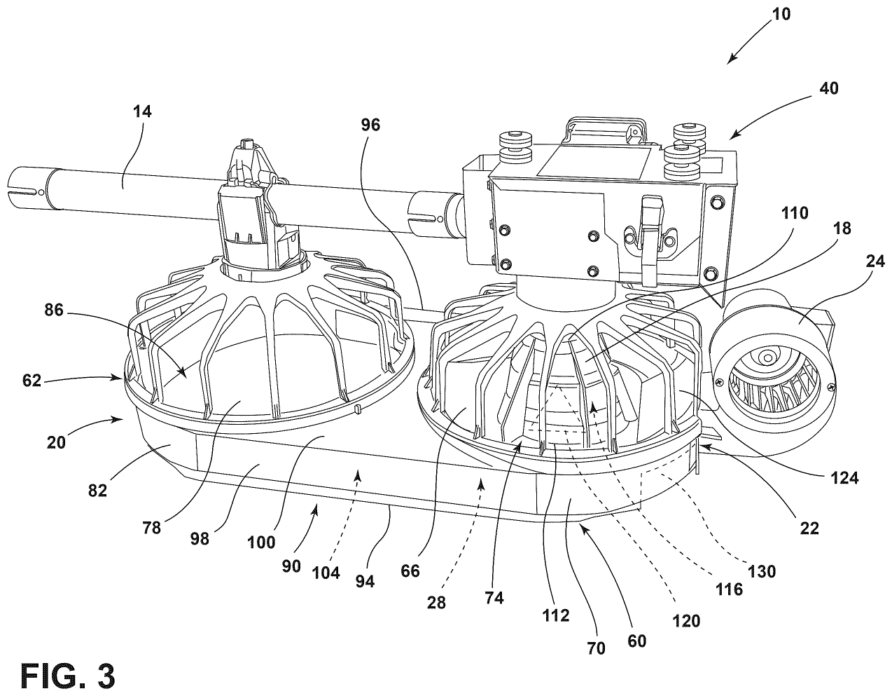

As shown in FIG. 3, a feed cone 120 may be coupled with or integrally formed with the bottom wall 66 of the primary feed pan 60 and may be configured to disperse feed within the feed pan 60 as it exits the feed chute 18. The feed cone 120 may be positioned to extend upward from the bottom wall 66 toward the second end 112 of the feed chute 18. The feed cone 120 may be positioned such that the feed cone 120 is aligned with the feed channel 116 such that feed passing through the feed channel 116 is guided outward of the feed channel 116 into the interior receiving space 74 of the primary feed pan 60. In various examples, the feed cone 120 may extend at least partially into the feed channel 116 of the feed chute 18. It will be understood that the shape and size of the feed cone 120 may be varied without departing from the scope of the present disclosure.

FIGS. 6A and 6B are schematic drawings of the system 10. In various examples, a chute switch 34 may be operably coupled or integrally formed with the feed chute 18. The chute switch 34 is in communication with the feed source 16 via a controller 38, as described in more detail elsewhere herein. The chute switch 34 may be positioned within the feed channel 116 of the feed chute 18 and operable between a first position and a second position (see FIG. 6A, where the chute switch 34 is shown without hatching to indicate a first position or a first state of the chute switch 34, and FIG. 6B, where the chute switch 34 is shown with hatching to indicate a second position or a second state of the chute switch 34). When a level of feed 30 within the feed chute 18 is below the position of the chute switch 34 within the feed channel 116 of the feed chute 18, the chute switch 34 is in the first position (FIG. 6A). When the chute switch 34 is in the first position, the feed source 16 is configured to provide feed to the feed chute 18. The feed source 16 may be configured to continue to provide feed to the feed chute 18 until the chute switch 34 is moved to the second position. Alternatively, it is contemplated that the feed source 16 may be configured to provide a predetermined level of feed to the feed chute 18 in response to the chute switch 34 being in the first position. When the level of feed 30 within the feed chute 18 is at or above the position of the chute switch 34 within the feed channel 116 of the feed chute 18, the chute switch 34 is in the second position (FIG. 6B). When the feed chute 18 is in the second position, the feed source 16 is configured to stop providing feed to the feed chute 18 until the chute switch 34 is moved to the first position.

Referring again to FIGS. 2 and 3, the side wall 70 of the primary feed pan 60 may define an airflow inlet 22. The airflow inlet 22 may be defined opposite the channel 104 extending between the interior receiving space 74 of the primary feed pan 60 and the interior receiving space 86 of the auxiliary feed pan 62. In other words, the airflow inlet 22 may be defined such that airflow directed through airflow inlet 22 is generally directed toward the channel 104.

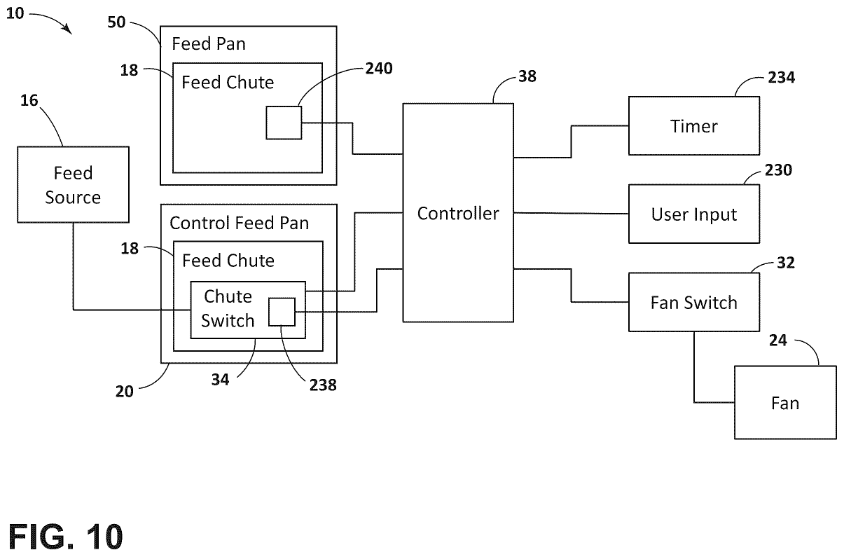

A fan 24 may be positioned adjacent to the control feed pan 20 and operable to provide an airflow to the interior 28 of the control feed pan 20 via the airflow inlet 22. The fan 24 is configured to be selectively actuated to provide airflow to move feed within the control feed pan 20 so that additional feed enters the control feed pan 20 from the feed chute 18, thereby lowering the level of feed 30 within the feed chute 18, as discussed in more detail elsewhere herein (FIG. 10). For example, as shown in FIGS. 2 and 3, the fan 24 may be operably coupled with the airflow inlet 22 of the primary feed pan 60. The airflow from the fan 24 may move feed from the interior receiving space 74 of the primary feed pan 60. Specifically, the airflow may be directed to move feed proximate the second end 112 of the feed chute 18 outward of the feed chute 18 and toward the channel 104 and the interior receiving space 84 of the auxiliary feed pan 62, allowing additional feed to be deposited from the feed chute 18 and reducing the level of feed within the feed chute 18.

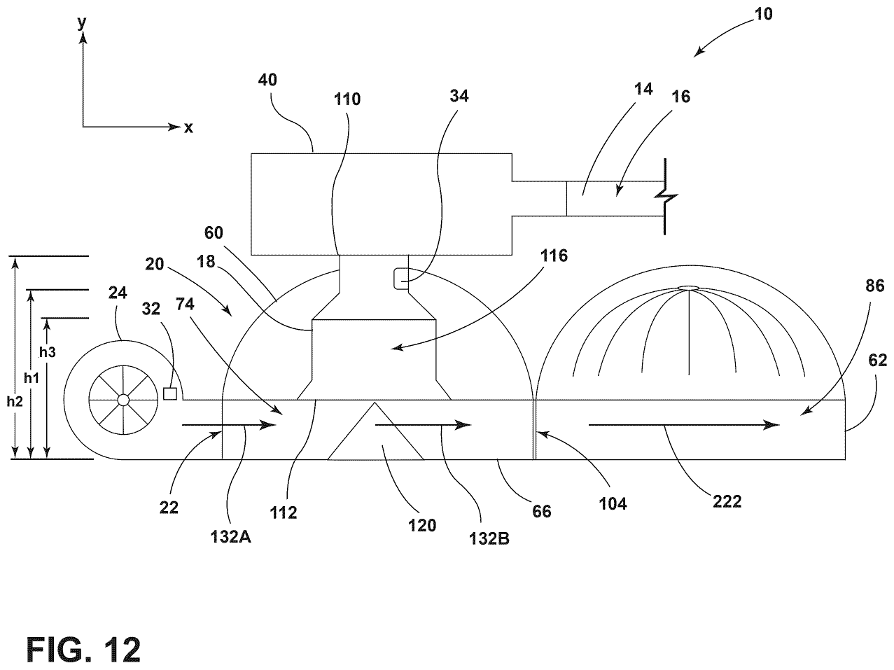

As discussed in more detail elsewhere herein, the fan 24 may be operable by a fan switch 32 (FIGS. 10 and 12). In other words, the fan switch 32 may be operable to control the fan 24. The fan switch 32 may be switchable between a first position or first state and a second position or second state. When the fan switch 32 is toggled to the first position, the fan 24 begins an operation to provide the airflow. The fan 24 is configured to continue to provide the airflow while the fan switch 32 is in the first position. When the fan switch 32 is toggled to a second position, the fan 24 is configured to stop the operation to provide the airflow. The operation to provide the airflow is stopped while the fan switch 32 is in the second position and is not resumed until the fan switch 32 is toggled back into the first position.

As shown in FIGS. 2 and 3, a baffle 124 may be positioned proximate the airflow inlet 22. The baffle 124 may be angled away from the airflow inlet 22 toward the bottom wall 66 of the primary feed pan 60 and may be configured to direct airflow from the airflow inlet 22 toward the bottom wall 66 of the primary feed pan 60. In various examples, the baffle 124 may further be configured to direct airflow from the airflow inlet 22 through an airflow guide 130 (FIG. 3), as described in more detail below.

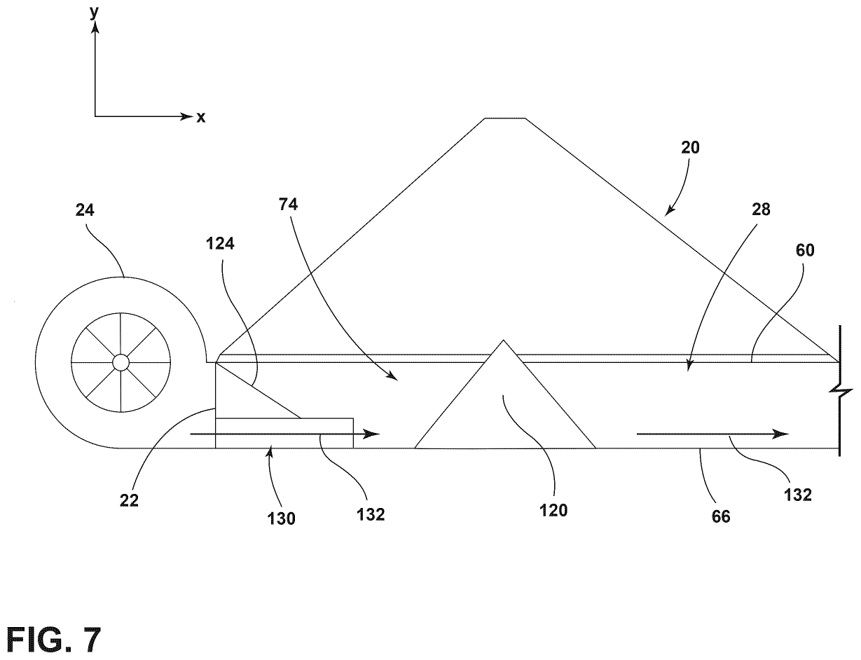

FIG. 7 is a schematic depiction of the primary feed pan 60 with the feed chute 18 removed. The airflow guide 130 may be positioned proximate the airflow inlet 22 and may be configured to guide airflow from the airflow inlet 22 into the interior receiving space 74 of the primary feed pan 60 along the path shown by arrows 132. In various examples, the airflow guide 130 may be integrally formed with the bottom wall 66 of the primary feed pan 60. In other examples, the airflow guide 130 may be coupled with the bottom wall 66 of the primary feed pan 60. In still other examples, the airflow guide 130 may be otherwise positioned within the interior receiving space 74 of the primary feed pan 60. The baffle 124 may extend at least partially over the airflow guide 130 to guide airflow from the airflow inlet 22 through the airflow guide 130. However, it is contemplated that the baffle 124 may extend over the entirety of the airflow guide 130 without departing from the scope of the present disclosure.

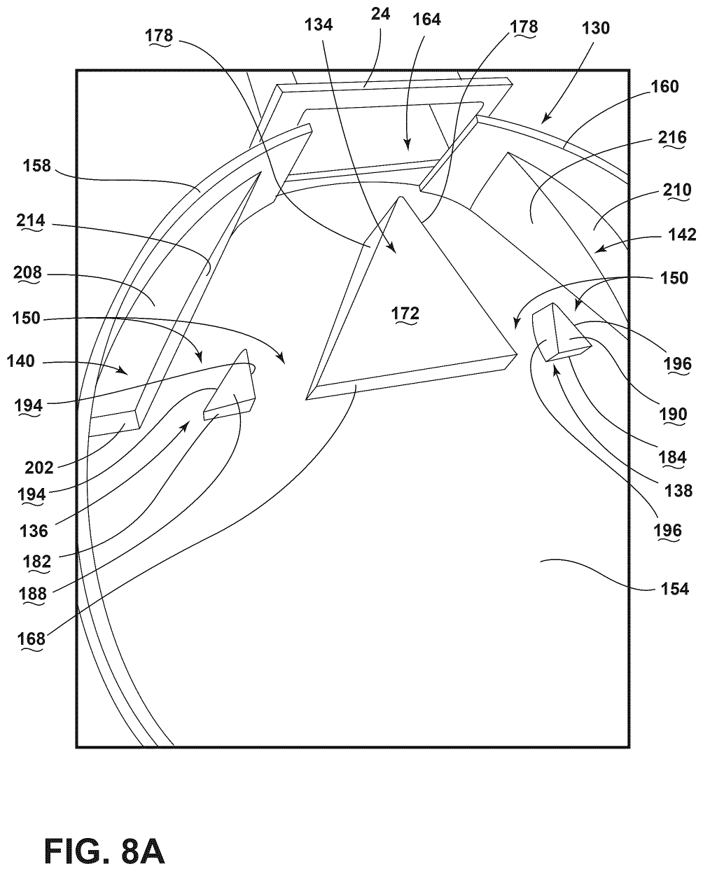

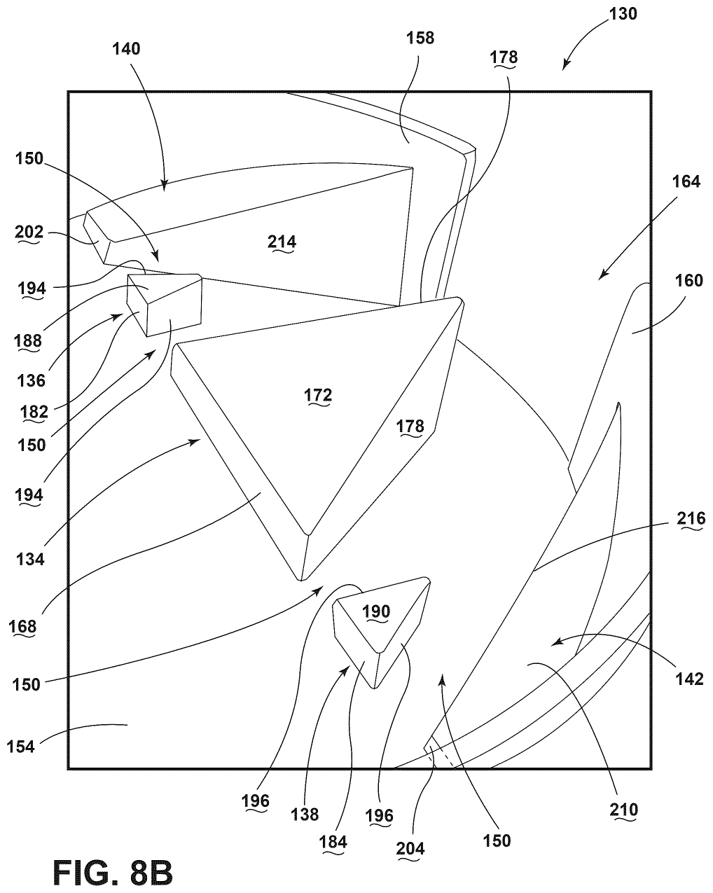

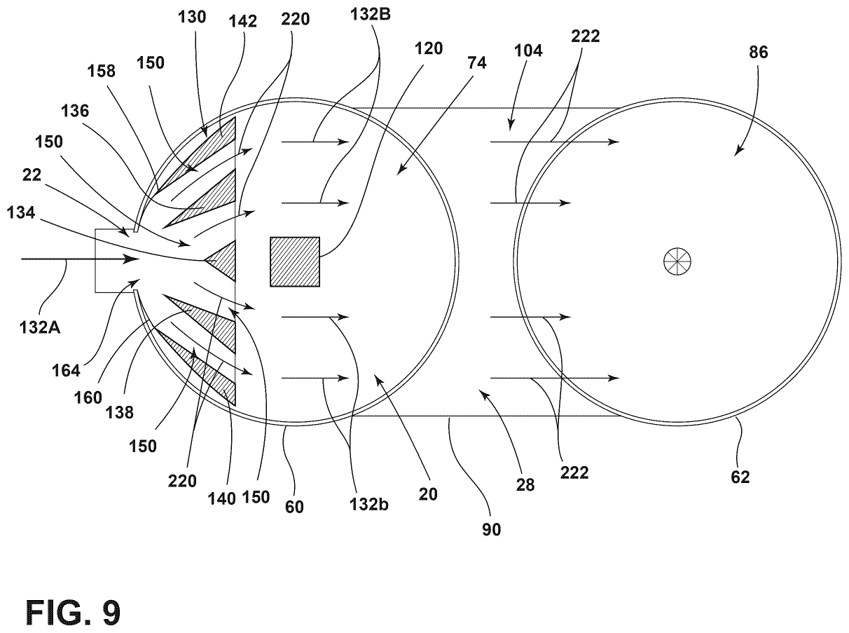

As shown in FIGS. 8A and 8B, which show various views of the airflow guide 130, the airflow guide 130 includes one or more protrusions 134, 136, 138, 140, 142 positioned to define a plurality of airflow channels 150 for guiding the airflow from the airflow inlet 22 and into the interior receiving space 74 of the primary feed pan 60. The airflow guide 130 may include a base 154 integrally formed with or in contact with the bottom wall 66 of the primary feed pan 60. Alternatively, the base 154 may be formed of the bottom wall 66 of the primary feed pan 60. First and second side walls 158, 160 may extend upward from the base 154 of the airflow guide 130 and define an opening 164 configured to be aligned with the airflow inlet 22 (FIG. 9). Where the base 154 is formed of the bottom wall 66 of the primary feed pan 60, the first and second side walls 158, 160 may be formed of the side wall 70 of the primary feed pan 60 and the opening 164 may be the airflow inlet 22. In other words, where the airflow guide 130 is at least partially formed of bottom wall 66 and/or the side wall 70 of the primary feed pan 60, the airflow guide 130 may comprise at least one air channel 150 defined by a portion of the primary feed pan 60 and one or more surfaces of at least one channel feature, such as the one or more protrusions 134, 136, 138, 140, 142.

The one or more protrusions 134, 136, 138, 140, 142 of the airflow guide 130 may include a central protrusion 134 extending upward from the base 154 and having a generally triangular vertical cross-section. The central protrusion 134 may include a forward surface 168 extending upward from the base 154 and integrally formed with an upper surface 172. The upper surface 172 may be positioned to slope downward toward the forward surface 168 from an apex proximate the opening 164 of the airflow guide 130. The central protrusion 134 may further have one or more vertical side surfaces 178 extending upward from the base 154 and at least partially defining one or more of the plurality of air channels 150.

First and second lateral protrusions 136, 138 may be positioned on either side of the central protrusion 134. Each of the first and second lateral protrusions 136, 138 may have a generally triangular vertical cross-section. Each of the first and second lateral protrusions 136, 138 may further have a forward surface 182, 184 extending upward from the base 154 and integrally formed with a respective upper surface 188, 190. Each of the upper surfaces 188, 190 may be positioned to slope downward toward the respective forward surface 182, 184 from an apex of the respective lateral protrusion 136, 138 proximate the opening 164 of the airflow guide 130. The forward surfaces 182, 184 of the first and second lateral protrusions 136, 138 may be substantially coplanar with the forward surface 168 of the central protrusion 134. Each of the first and second lateral protrusions 136, 138 may further include one or more respective vertical side surfaces 194, 196 extending from the base 154 upward to the respective upper surface 188, 190 and at least partially defining one or more of the plurality of air channels 150.

Third and fourth lateral protrusions 140, 142 may be integrally formed with the respective side walls 158, 160 of the airflow guide 130. Each of the third and fourth lateral protrusions 140, 142 may include a respective forward surface 202, 204. The forward surfaces 202, 204 of the third and fourth lateral protrusions 140, 142 may be coplanar with the forward surface 168 of the central protrusion 134 and/or the forward surfaces 182, 184 of the first and second lateral protrusions 136, 138. Each of the third and fourth lateral protrusions 140, 142 may further include a respective upper surface 208, 210 extending from an apex of the respective lateral protrusion 140, 142 downward toward the respective forward surface 202, 204. Each of the third and fourth lateral protrusions 140, 142 may further include one or more respective vertical side surfaces 214, 216 extending from the base 154 upward to the respective upper surface 208, 210 and at least partially defining one or more of the plurality of air channels 150. It is contemplated that the any of the protrusions 134, 136, 138, 140, 142 described herein may have other shapes that allow the airflow to be directed to remove feed from beneath the feed chute 18.

FIG. 9 is a schematic cross-section of the control feed pan 20 including the primary feed pan 60, the central portion 90, and the auxiliary feed pan 62. The airflow guide 130 is positioned within the primary feed pan 60. As shown in FIG. 9 and previously described with respect FIGS. 8A and 8B, the protrusions 134, 136, 138, 140, 142 of the airflow guide 130 define the plurality of airflow channels 150. The plurality of airflow channels 150 are configured to channel the airflow entering the airflow inlet 22 along the path illustrated by arrow 132A along a plurality of airflow paths illustrated by arrows 220 after the airflow passes through the airflow inlet 22. The plurality of airflow paths 220 are configured to direct airflow across the feed cone 120 to move feed from around the feed cone 120. The plurality of airflow paths 220 provide airflow that may limit the amount of feed blowing out of the control pan 20 and may further force the airflow toward the bottom wall 66 of the primary feed pan 60. In other words, the protrusions 134, 136, 138, 140, 142 of the airflow guide 130 are configured to direct airflow from the airflow inlet 22 through the plurality of airflow channels 150 toward the bottom wall 66 of the primary feed pan 60 and/or across the feed cone 120 to move feed from around the feed cone 120 and into the auxiliary feed pan 62. Airflow passing through the plurality of channels 150 along the plurality of airflow paths 220 may flow across one or more surfaces of the protrusions 134, 136, 138, 140, 142 (e.g., across one or more of the vertical surfaces 178, 194, 196, 214, 216). The airflow may be directed by the protrusions 134, 136, 138, 140, 142 through the plurality of channels 150 to push feed located in the interior receiving space 74 of the primary feed pan 60 toward and/or into the interior receiving space 86 of the auxiliary feed pan 62.

With continued reference to FIG. 9, airflow channeled through the plurality of airflow channels 150 and directed across the feed cone 120 continues to move along the path shown by arrows 132B to move feed toward and through the channel 104 of the central portion 90. The feed is then moved through the channel 104 and into the interior receiving space 84 of the auxiliary feed pan 62, as shown by arrows 222. This allows feed to be moved by the airflow out of the primary feed pan 60 and into the auxiliary feed pan 62, which allows additional feed to enter the interior receiving space 74 of the primary feed pan 60, lowering the level of feed in the feed chute 18.

FIG. 10 is a block diagram of the system 10 according to various examples of the present disclosure. As illustrated in FIG. 10, the controller 38 may be coupled with the fan switch 32 and may be configured to communicate with the fan switch 32 to move the fan switch 32 from a first position, in which the fan switch 32 is in a first state (e.g., on or off), to a second position, in which the fan switch 32 is in a second state (e.g., on or off, different from the first state). The controller 38 may be configured to move the fan switch 32 from a first position to a second position to selectively actuate the fan 24 to provide the airflow which lowers the level of feed 30 within the feed chute 18 of the control feed pan 20 (e.g., the primary feed pan 60), as described in more detail elsewhere herein. The controller 38 may further be coupled with the chute switch 34 and may be configured to receive information from the chute switch 34 to determine when to selectively actuate the fan 24 by changing the position and/or state of the fan switch 32, as described in more detail elsewhere herein. The controller 38 may further be configured to receive information from a user input 230, a timer 234, and/or a feed sensor 238 to determine when the selectively actuate the fan 24 by changing the position and/or state of the fan switch 32.

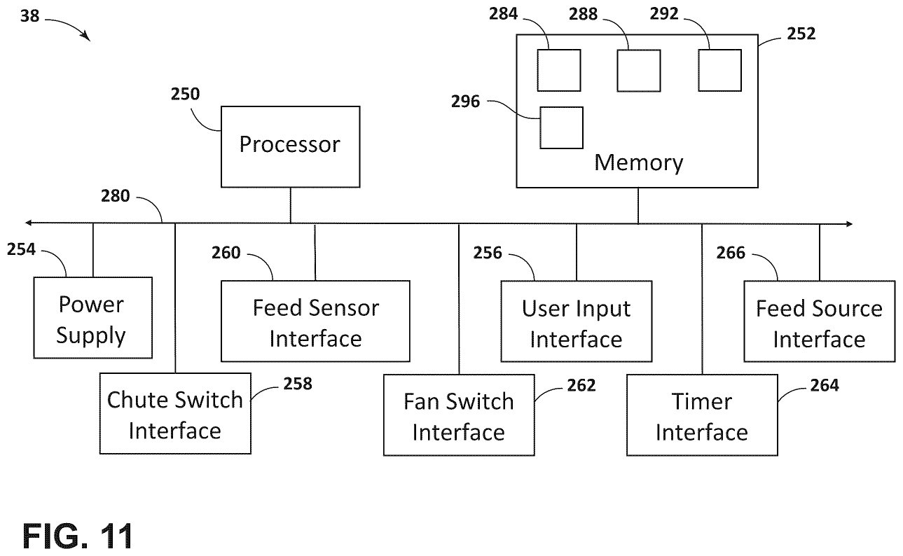

Referring now to FIG. 11, a block diagram of the controller 38 is shown. The controller 38 may be an electronic device comprising hardware, software, and combinations thereof configured to permit determination that the fan 24 needs to be activated. In some embodiments, the controller 38 may include at least one processor 250, memory 252, a power supply 254, a user input interface 256, a chute switch interface 258, a feed sensor interface 260, a fan switch interface 262, a timer interface 264, and a feed source interface 266. The processor 250 may execute the instructions of the memory 252 to interact with and control one or more other components of the controller 38. Although the processor 250 may communicate with other components of the controller 38 in any suitable manner, in various examples, the processor 250 communicates to and drives the other elements coupled with the controller 38 via a local interface 280, which can include one or more communication buses such as a central processing unit (CPU) or a digital signal processor (DSP). The local interface 280 is also communicatively coupled with the memory 252, which is described further below. In one embodiment, the processor 250 may execute instructions of the memory 252 and based on those instructions may communicate with the other components of the controller 38 via the communication buses of the local interface 280.

The power source 254 of the controller 38 provides power to resources of the controller 38, and can be an onboard power supply, such as a battery (e.g., a direct current power source), or can be off-board power to which the controller 38 is coupled to receive power (e.g., wired to an external power source, such as the nominal 120 V AC power source within the building).

The memory 252 may include various tangible or non-transitory storage media. Examples of tangible (or non-transitory) storage medium include disks, thumb drives, and memory, etc., but does not include propagated signals. Tangible computer readable storage media may include volatile and non-volatile, removable and non-removable media, such as computer readable instructions, data structures, program modules or other data. Examples of such media include RAM, ROM, EPROM, EEPROM, SRAM, flash memory, disks or optical storage, magnetic storage, or any other non-transitory medium that stores information that is accessed by a processor or computing device. The memory 252 may be configured to store control logic 284, user input data 288, timer data 292, or other data provided by the components of the system 10 to the controller 38 for use by the controller 38 in determining whether to take actions regarding one or more of the components as described in more detail elsewhere herein.

The user input interface 256 may comprise software, hardware, or any combination of hardware and software for coupling the controller 38 communicatively with a user input 230. The user input 230 could be a user device (e.g., a mobile device, a computer, etc.), a user operable-switch, or any other input that permits a user to provide input to toggle the fan switch 32 between the first and second positions and/or toggle the chute switch 34 between the first and second positions.

Referring still to FIGS. 10-12, the user input interface 256 may be configured to receive user input data 288 from the user input 230. User input data 288 may be communicated to the controller 38 via the user input interface 256 and may be stored within the memory 252 for use by the controller 38 when determining if the fan switch 32 should be in a first state or a second state. For example, a user may provide input to the controller 38 to actuate the fan 24 in specified time intervals or in response to information from one or more sensors (e.g., the feed sensor 238) within the system 10. A user may further be able to provide instructions from the user input 230 to the controller 38 to manually operate one or both of the fan switch 32 and the chute switch 34 between first and second states.

In other examples, the controller 38 may receive timer data 292 from the timer 234. In various examples, the timer 234 may be integrally formed with the user input 230. In other examples, the timer 234 may include a user-interface for toggling the fan switch 32 between at least the first position and the second position based on a user-selected duration measured by the timer 234 (e.g., one or more predetermined time intervals). The timer 234 may be in communication with the controller 38 via the timer interface 264. The timer interface 264 may comprise software, hardware, or any combination of hardware and software for coupling the controller 38 communicatively with the timer 234. The fan switch interface 262 may be configured for wired (ethernet, USB, etc.) or wireless (Bluetooth, WiFi, NFC, etc.) communication and may comprise a plurality of physical interfaces in various examples.

In various examples, the timer 234 may be configured to provide timer data 292 in response to requests from the controller 38 prompted by the user input 230. Such timer data 292 may be indicative of time associated with fan activation, such as elapsed time since the fan 24 was turned on, time remaining until the fan 24 should turn off, a time until the fan 24 should resume operation, or other information regarding time associated with the system 10 and its operation. The controller 38 may use the timer data 292 to determine that one or both of the fan switch 32 and the chute switch 34 should be in a first state or a second state. For example, the timer 234 may be configured to provide for the fan switch 32 to be toggled from the first position to the second position after a predetermined time interval or may be configured to provide for the chute switch 34 to be moved from the first position to the second position after a predetermined time interval. In some examples, the timer 234 may be one of a plurality of timers such that the fan switch 32 and the chute switch 34 may be separately operable on timed intervals.

Referring again to FIG. 11, the controller 38 may include the chute switch interface 258 comprising software, hardware, or any combination of hardware and software for coupling the controller 38 communicatively with the chute switch 34. The chute switch interface 258 may be configured for wired (ethernet, USB, etc.) or wireless (Bluetooth, WiFi, NFC, etc.) communication and may comprise a plurality of physical interfaces in various examples. The chute switch interface 258 may be configured to allow the controller 38 to determine if the chute switch 34 is in the first position or the second position.

As shown in FIGS. 10 and 12, in some examples, the chute switch 34 may include a control feed level sensor 238 operable to sense a feed level within the feed chute 18. The control feed level sensor 238 may comprise an infrared sensor, an image sensor, a pressure sensor, or any other type of sensor configured to provide feedback about the level of feed within the feed chute 18 of the control feed pan 20.

As best shown in FIG. 11, the system 10 may further include one or more auxiliary feed level sensors 240 positioned within one or more of the plurality of feed pans 50. It is contemplated that the one or more auxiliary feed level sensors 240 may be one of a plurality of feed level sensors positioned in other feed pans 50 along the poultry network 12 (FIG. 1) to determine the feed level in one or more of the plurality of feed pans 50 such that the controller 38 may receive sensor data 296 about one or more feed pans 50 within the network 12 without departing from the scope of the present disclosure. Each auxiliary feed level sensor 240 may be operable to sense a feed level within the feed chute 18 of the respective feed pan 50. The one or more auxiliary feed level sensors 240 may each comprise an infrared sensor, an image sensor, a pressure sensor, or any other type of sensor configured to provide feedback about the level of feed within the feed chute 18 of the respective feed pan 50.

As shown in FIGS. 10 and 11, the controller 38 may be configured to be in communication with one or more of the feed level sensors 238, 240 via the feed sensor interface 260. The feed sensor interface 260 may comprise software, hardware, or any combination of hardware and software for coupling the controller 38 communicatively with the feed sensor 238. The feed sensor interface 260 may be configured for wired (ethernet, USB, etc.) or wireless (Bluetooth, WiFi, NFC, etc.) communication and may comprise a plurality of physical interfaces in various examples. In other words, any one of the feed level sensors 238, 240 may be in wireless communication with the controller 38.

Referring again to FIG. 11, the controller 38 may further include the fan switch interface 262 configured to allow the controller 38 to communicate with the fan switch 32. The fan switch interface 262 may comprise software, hardware, or any combination of hardware and software for coupling the controller 38 communicatively with the fan switch 32. The fan switch interface 262 may be configured for wired (ethernet, USB, etc.) or wireless (Bluetooth, WiFi, NFC, etc.) communication and may comprise a plurality of physical interfaces in various examples. The fan switch interface 262 is configured to allow the controller 38 to toggle the fan switch 32 between the first position and the second position, which correspond with a first state of the fan switch 32 and a second state of the fan switch 32. Where the fan switch 32 is a manual switch, the fan switch 32 may be configured to provide at least one signal to the controller 38 via the fan switch interface 262, and the controller 38 may be configured to determine the position of the fan switch 32.

The controller 38 may further be communication with the feed source 16 and may be configured to selectively control the feed source 16 to provide feed to the feedline 14 in response to the chute switch 34 being in the first position or first state. The feed source interface 266 may comprise software, hardware, or any combination of hardware and software for coupling the controller 38 communicatively with the feed source 16. The feed source interface 266 may be configured for wired (ethernet, USB, etc.) or wireless (Bluetooth, WiFi, NFC, etc.) communication and may comprise a plurality of physical interfaces in various examples.

The memory 252 may comprise one or more memories configured to store control logic 284. The control logic 284 comprises instructions for generally controlling the operation of the controller 38 and its various resources to perform actions to carry out essentially any function ascribed herein to the controller 38 and system 10, and thus actions attributed to the controller 38 and more generally system 10 may be based on execution by the processor 250 of instructions stored in memory 252 as logic 284. It should be noted that the control logic 284 may be implemented in software, hardware, firmware, or any combination thereof. Note also that the control logic 284, when implemented in software, can be stored and transported on any computer-readable medium for use by or in connection with an instruction execution apparatus that can fetch and execute instructions. In the context of this document, a “computer-readable medium” can be any means that can contain or store a program for use by or in connection with an instruction execution apparatus.

In various examples, the control logic 284 may include instructions that cause the controller 38 to perform various tasks to control a level of feed within one or more pans of the feed network. In some embodiments, such instructions may cause the controller 38 to determine the position of one or both of the chute switch 34 and the fan switch 32. As shown in FIG. 12, and as discussed elsewhere herein, the chute switch 34 may be positioned within the feed chute 18 and may be operable between a first position corresponding with a first state and a second position corresponding with a second state. The chute switch 34 is located at a first height h1 within the feed chute 18 as measured from the bottom wall 66 of the primary feed pan 60. When the level of feed 30 (see FIGS. 6A and 6B) is above the first height h1 (e.g., at a second height h2), the chute switch 34 is in the second position or the second state. When the controller 38 determines that the chute switch 34 is in the second position, the control logic 284 may include instructions to cause the controller 38 to communicate with the feed source 16 to stop the flow of feed from the feed source 16 to the feed chute 18 via the feedline 14. When the level of feed 30 (see FIGS. 6A and 6B) is below the first height h1 (e.g., at a third height h3), the chute switch 34 is switched to the first position or the first state. When the controller 38 determines that the chute switch 34 is in the first position or the first state, the control logic 284 may include instructions to cause the controller 38 to communicate with the feed source 16 to provide feed to the feed chute 18.

As shown in FIG. 12, the fan 24 may be aligned with the airflow inlet 22 and may be operably coupled with the fan switch 32. The fan switch 32 may be operable between a first position or first state and a second position or second state. The fan switch 32 may be manually operated by a user or may be controlled by the controller 38 in response to determination by the controller 38 of a state of one or more other components. For example, the control logic 284 of the controller 38 may include instructions to cause the controller 38 to determine whether the fan switch 32 should be moved to one of the first or second positions or states in response to user input data 288 from the user input 230, timer data from the timer 234, or other data stored within the memory 252. Where the user input 230 is a separate switch, the controller 38 may be configured to determine the state of the user input 230 and selectively operate the fan switch 32 between the first and second states in response to the state of the user input 230.

With continued reference to FIGS. 10-12, in operation, the controller 38 may be configured to operate the system 10 to cause various actions, as previously described. In operation, the controller 38 is configured to determine if feed should be moved from the primary feed pan 60 into the auxiliary feed pan 62. In other words, the controller 38 is configured to determine when to move the fan switch 32 to the first position when the controller 38 determines that feed should be moved (e.g., that the feed level in the chute of the control pan is preventing the feed source from providing additional feed to pans down the feed line that need more feed). In various examples, when the controller 38 determines that a first predetermined time interval has elapsed based on timer data 292, the control logic 284 may include instructions to cause the controller 38 to toggle the fan switch 32 to the first position. In other examples, when the controller determines that the chute switch 34 is in the second position and the feed level within one of the plurality of feed pans 50 is below a desired level based on sensor data 296 from the one or more feed level sensors 238, 240, the control logic 284 may include instructions to cause the controller 38 to toggle the fan switch 32 to the first position. In still other examples, when the controller 38 determines using user input data 288 that user input has been provided to switch the fan switch 32 to a first position, the control logic 284 may include instructions to cause the controller 38 to toggle the fan switch 32 to the first position. In the first position, the fan switch 32 is configured to actuate the fan 24 to provide airflow through the airflow inlet 22 along the path 132A to move the feed from the interior receiving space 74 of the primary feed pan 60 and into the interior receiving space 86 of the auxiliary feed pan 62.

The controller 38 may further be configured to toggle the fan switch 32 to the second position to stop airflow through the airflow inlet 22. For example, when the controller 38 determines that a second predetermined time interval has elapsed based on timer data 292, the control logic 284 may include instructions to cause the controller 38 to toggle the fan switch 32 to the second position. In other examples, when the controller determines that the chute switch 34 is in the first position and the feed level within one of the plurality of feed pans 50 is at or above a desired level based on sensor data 296, the control logic 284 may include instructions to cause the controller 38 to toggle the fan switch 32 to the second position. In still other examples, when the controller 38 determines using user input data 288 that user input has been provided to switch the fan switch 32 to the second position, the control logic 284 may include instructions to cause the controller 38 to toggle the fan switch 32 to the second position. In the second position, the fan switch 32 is configured to operate the fan 24 to stop airflow through the airflow inlet 22.

As previously introduced, the poultry feed network 12 of the includes the control feed pan 20, which may include the primary feed pan 60 and the auxiliary feed pan 62. When chickens cat feed from the other feed pans 50 within the network 12, but do not eat from the control feed pan 20, one or more of the plurality of feed pans 50 may be empty while the control feed pan 20 remains full. This causes the chute switch 34 to not be activated, and so additional feed is not delivered to the plurality of feed pans 50. Providing the airflow through the airflow inlet 22 moves feed from around the feed cone 120 (e.g., into the auxiliary feed pan 62) to provide space between the edges of the control feed pan 20 and the feed cone. This may create a situation where there is insufficient feed between edges of the control feed pan 20 and around the feed cone 120 (e.g., closer to the chute 18) to counteract the weight of feed in the chute 18, and the feed in the chute 18 pushes outward and into the interior of the primary feed pan 60. The feed cone 120 pushes the feed toward empty space between the cone 120 and edges of the primary feed pan 60 to backfill feed moved by the airflow. Feed may continue to exit the feed chute 18 of the control feed pan 20 until there is sufficient feed to counteract the weight of feed in the feed chute 18 and keep additional feed from leaving the feed chute 18 and entering the pan 20. This is configured to allow feed to be deposited in the other feed pans 50 of the network 12 even when chickens are not eating feed within the control feed pan 20.

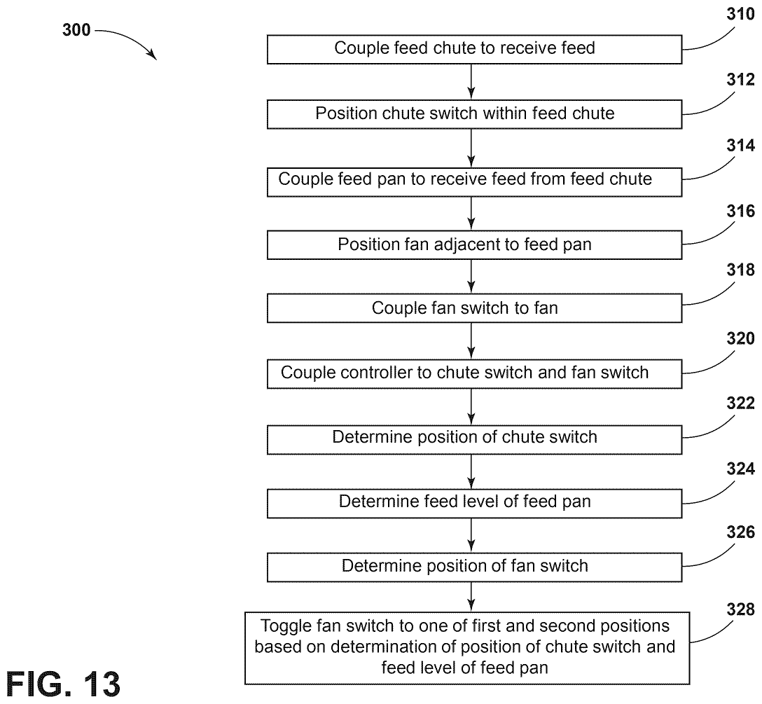

Referring now to FIG. 13, a non-limiting flow chart for an exemplary method 300 for controlling feed to a poultry feed network 12 is shown. The method 300 includes a first step 310 of coupling a feed chute 18 to receive feed from a feed source 16 via a feedline 14. A chute switch 34 is positioned within the feed chute 18 (step 312). The chute switch 34 may be positioned within the feed chute 18 when the feed chute 18 is fabricated or may be positioned within the feed chute 18 after the feed chute 18 is fabricated by a user of the poultry feed network 12. As shown in FIG. 10, the chute switch 34 is communication with the feed source 16. In various examples, the chute switch 34 may comprise a feed sensor 238 operable to sense a feed level within the feed chute 18. The chute switch 34 may be switchable between at least two positions, as described in more detail elsewhere herein. A first position of the chute switch 34 indicates that a level of feed 30 within the feed chute 18 is below the position of the chute switch 34 within the feed chute 18, and a second position of the chute switch 34 indicates that the level of feed 30 within the feed chute 18 is above the position of the chute switch 34 within the feed chute 18. When the chute switch 34 is in the first position, the feed source 16 provides feed to the feed chute 18, and, when the chute switch 34 is in the second position the feed source 16 stops providing feed to the feed chute 18.

Another step 314 of the method 300 may include coupling a feed pan 20, 50, 60 with the feed chute 18 to receive feed from the feed chute 18. In various examples, the feed pan 20, 60 may comprise an airflow inlet 22. The method 300 may further include a step 316 of positioning a fan 24 adjacent to the feed pan 20, 60 when the feed pan 20, 60 comprises an airflow inlet 22 such that the fan 24 is operable to provide an airflow to an interior 28 of the feed pan 20, 60 via the airflow inlet 22. Airflow moves feed within the feed pan 20, 60 so that additional feed enters the feed pan 20, 60 from the feed chute 18, thereby lowering the level of feed 30 within the feed chute 18.

As shown in FIGS. 8A and 8B, the feed pan 20, 60 may comprise at least one air channel 150 defined by a portion of the feed pan 20, 60 and one or more surfaces of at least one channel feature (e.g., surfaces 178, 194, 196, 214, 216 of the protrusions 134, 136, 138, 140, 142) as described in more detail elsewhere herein. The airflow from the airflow inlet 22 is channeled through the at least one air channel 150 after it passes through the airflow inlet 22.

As described in more detail elsewhere herein, the feed pan 20 may further comprise an auxiliary feed pan 62 configured to receive feed from the feed pan 60 when the airflow moves feed within the feed pan 20 so that additional feed enters the feed pan 60 from the feed chute 18 (see FIG. 12).

A fan switch 32 may be coupled with the fan 24 in another step 318. The fan switch 32 may be switchable between at least two positions and operable to control operation of the fan 24. The fan 24 may be configured to begin an operation to provide the airflow when the fan switch 32 is in a first position, and the fan 24 may be configured to stop the operation to provide the airflow when the fan switch 32 is in a second position, as described in more detail elsewhere herein. In various examples, the fan switch 32 may comprise a user-operable switch.

The method 300 may further include a step 320 of coupling a controller 38 to the chute switch 34 and the fan switch 32. The controller 38 may comprise instructions (e.g., control logic 284) stored in memory 252 which, when executed by the controller 38, may cause the controller 38 to perform actions. The controller 38 may determine the position of the chute switch (step 322) and may determine a feed level within a feed chute 18 of a second feed pan 50 (step 324).

The controller 38 may further determine the position of the fan switch 32 in another step 326 of the method 300. Determination of the position of the fan switch 32 may be performed by the controller 38 when the fan switch 32 provides at least one signal to the controller 38 indicating when a user has toggled the fan switch 32 between at least the first position and the second position.

The method 300 may further include a step 328 in which the controller 38 may toggled the fan switch 32 to the first position in response to a determination that the chute switch 34 is in the second position and that a feed level within a second feed pan 50 is below a desired level and/or may toggle the fan switch 32 to the second position in response to a determination that the chute switch 34 is in the first position and that the feed level within the second feed pan 50 is at or above the desired level. Determination that the feed level within the second feed pan 50 is below a desired level may be based on a signal from a feed level sensor 240 positioned on the second feed pan 50 and in communication with the controller 38 (step 324). The feed level sensor 240 may be in configured to communicate wirelessly with the controller 38. However, it will be understood that the feed level sensor 240 may be in communication with the controller 38 via other means (e.g., a feed sensor interface), as described elsewhere herein.

It should be noted that, while the system 10 is described throughout this disclosure as including a control pan, it is contemplated that the system 10 may be configured to be selectively coupled with an existing control pan (e.g., configured to replace a bottom wall of an existing control pan) to adapt an existing control pan without needing to replace the control pan. In other words, the system 10 may be coupled directly to the feedline 14 as a control pan or may be configured to adapt an existing control pan without departing from the scope of the present disclosure.

It will be understood by one having ordinary skill in the art that construction of the described concepts, and other components, is not limited to any specific material. Other exemplary embodiments of the concepts disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

What is claimed is:

1. A system for controlling a feed level in a poultry feed network, comprising:
a feed chute coupled to receive feed from a feed source via a feedline;
a chute switch positioned within the feed chute, in communication with the feed source, and switchable between at least two positions, wherein a first position of the chute switch indicates that a level of feed within the feed chute is below the position of the chute switch within the feed chute, wherein a second position of the chute switch indicates that a level of feed within the feed chute is at or above the position of the chute switch within the feed chute, wherein when the chute switch is in the first position, the feed source provides feed to the feed chute, and wherein when the chute switch is in the second position the feed source stops providing feed to the feed chute;
a feed pan coupled to receive feed from the feed chute, the feed pan comprising an airflow inlet;
a fan positioned adjacent to the feed pan and operable to provide an airflow to an interior of the feed pan via the airflow inlet, wherein the airflow moves feed within the feed pan so that additional feed enters the feed pan from the feed chute, thereby lowering a level of feed within the feed chute; and
a fan switch coupled to the fan, switchable between at least two positions and operable to control operation of the fan, wherein the fan begins an operation to provide the airflow when the fan switch is toggled to a first position, and wherein the fan stops the operation to provide the airflow when the fan switch is toggled to a second position.

2. The system of claim 1, wherein fan switch comprises a user-operable switch.

3. The system of claim 1, wherein chute switch comprises a feed sensor operable to sense a feed level within the feed chute.

4. The system of claim 1, further comprising:
a controller coupled to the chute switch and the fan switch and comprising instructions stored in memory which, when executed by the controller, cause the controller to perform actions comprising:
toggling the fan switch to the first position in response to a determination that the chute switch is in the second position and that a feed level within a second feed pan is below a desired level; and
toggling the fan switch to the second position in response to a determination that the chute switch is in the first position and that the feed level within the second feed pan is at or above the desired level.

5. The system of claim 4, wherein the determination that the feed level within the second feed pan is below a desired level is based on a signal from a feed level sensor positioned on the second feed pan and in communication with the controller.

6. The system of claim 5, wherein the feed level sensor is configured to communicate wirelessly with the controller.

7. The system of claim 1, wherein the feed pan comprises at least one air channel defined by a portion of the feed pan and one or more surfaces of at least one channel feature, wherein the airflow is channeled through the at least one air channel after it passes through the airflow inlet.

8. The system of claim 1, further comprising an auxiliary feed pan, wherein the auxiliary feed pan is coupled to receive feed from the feed pan when the airflow moves feed within the feed pan so that additional feed enters the feed pan from the feed chute.

9. The system of claim 2, wherein the fan switch provides at least one signal to the controller indicating when the user has toggled the fan switch between at least the first position and the second position.

10. The system of claim 2, wherein the fan switch comprises a timer, and wherein the timer comprises a user-interface for toggling the fan switch between at least the first position and the second position based on a user-selected duration measured by the timer.

11. A method for controlling a feed level in a poultry feed network, comprising:
coupling a feed chute to receive feed from a feed source via a feedline;
positioning a chute switch within the feed chute, in communication with the feed source, and switchable between at least two positions, wherein a first position of the chute switch indicates that a level of feed within the feed chute is below the position of the chute switch within the feed chute, wherein a second position of the chute switch indicates that a level of feed within the feed chute is at or above the position of the chute switch within the feed chute, wherein when the chute switch is in the first position, the feed source provides feed to the feed chute, and wherein when the chute switch is in the second position the feed source stops providing feed to the feed chute;
coupling a feed pan to receive feed from the feed chute, the feed pan comprising an airflow inlet;
positioning a fan adjacent to the feed pan and operable to provide an airflow to an interior of the feed pan via the airflow inlet, wherein the airflow moves feed within the feed pan so that additional feed enters the feed pan from the feed chute, thereby lowering a level of feed within the feed chute; and
coupling a fan switch to the fan, wherein the fan switch is switchable between at least two positions and operable to control operation of the fan, wherein the fan begins operation to provide the airflow when the fan switch is in a first position, and wherein the fan stops operation to provide the airflow when the fan switch is in a second position.

12. The method of claim 11, wherein fan switch comprises a user-operable switch.

13. The method of claim 11, wherein chute switch comprises a feed sensor operable to sense a feed level within the feed chute.

14. The method of claim 11, further comprising:
coupling a controller to the chute switch and the fan switch and comprising instructions stored in memory which, when executed by the controller, cause the controller to perform actions comprising:
toggling the fan switch to the first position in response to a determination that the chute switch is in the second position and that a feed level within a second feed pan is below a desired level; and
toggling the fan switch to the second position in response to a determination that the chute switch is in the first position and that the feed level within the second feed pan is at or above the desired level.

15. The method of claim 14, wherein the determination that the feed level within the second feed pan is below a desired level is based on a signal from a feed level sensor positioned on the second feed pan and in communication with the controller.

16. The method of claim 15, wherein the feed level sensor is configured to communicate wirelessly with the controller.

17. The method of claim 11, wherein the feed pan comprises at least one air channel defined by a portion of the feed pan and one or more surfaces of at least one channel feature, wherein the airflow is channeled through the at least one air channel after it passes through the airflow inlet.

18. The method of claim 11, further comprising an auxiliary feed pan, wherein the auxiliary feed pan is coupled to receive feed from the feed pan when the airflow moves feed within the feed pan so that additional feed enters the feed pan from the feed chute.

19. The method of claim 12, wherein the fan switch provides at least one signal to the controller indicating when the user has toggled the fan switch between at least the first position and the second position.

20. A system for controlling a feed level in a poultry feed network, comprising:
a feed chute coupled to receive feed from a feed source via a feedline;
a feed pan coupled to receive feed from the feed chute, the feed pan comprising an airflow inlet;
a fan positioned adjacent to the feed pan and operable to provide an airflow to an interior of the feed pan via the airflow inlet, wherein the airflow moves feed within the feed pan so that additional feed enters the feed pan from the feed chute, thereby lowering a level of feed within the feed chute; and
a user-operable fan switch coupled to the fan, switchable between at least two positions and operable to control operation of the fan, wherein the fan begins operation to provide the airflow when the fan switch is toggled to a first position, and wherein the fan stops operation to provide the airflow when the fan switch is toggled to a second position.
